(19) United States
(12) Patent Application Publication
(10) Pub. No.: US 2019/0388838 A1
(43) Pub. Date: Dec. 26, 2019

(54) CATALYST COMPOSITION COMPRISING COLLOIDAL PLATINUM GROUP METAL NANOPARTICLES

(71) Applicant: BASF Corporation, Florham Park, NJ (US)

(72) Inventors: Tian Luo, Piscataway, NJ (US); Michel Deeba, East Brunswick, NJ (US); Yunlong Gu, Edison, NJ (US); Stephan Deuerlein, Schifferstadt (DE); Emi Leung, Somerset, NJ (US)

(73) Assignee: BASF Corporation, Florham Park, NJ (US)

(21) Appl. No.: 16/481,574

(22) PCT Filed: Jan. 26, 2018
(86) PCT No.: PCT/IB2018/050501

§ 371 Date: Jul. 29, 2019

Related U.S. Application Data
(60) Provisional application No. 62/451,130, filed on Jan. 27, 2017.

(51) Int. Cl. B01D 53/94; B01J 23/63; B01J 35/04; B01J 35/00; B01J 21/04; B01J 37/02; B01J 37/16; B01J 37/08; F01N 3/10; F01N 3/28

(52) U.S. Cl. CPC B01D 53/945; F01N 2510/06; B01J 35/04; B01J 35/0013; B01J 21/04; B01J 35/006; B01J 37/0203; B01J 37/16; B01J 37/08; B01D 53/9468; B01D 53/9472; F01N 3/101; F01N 3/2828; B01D 2255/1023; B01D 2255/9202; B01D 2255/9155; B01D 2255/2063; F01N 2330/06; F01N 2370/02; B01J 23/63

(57) ABSTRACT

The present invention relates to catalyst compositions effective for carrying out three-way conversion including platinum group metal nanoparticles (e.g., nanoparticles of Pt, Pd, Au, Ru, Rh, alloys thereof, and mixtures thereof), the nanoparticles having an average particle size of 15 to 50 nm, wherein the nanoparticles are dispersed on a refractory metal oxide component. In some such catalyst compositions, a significant portion, e.g., at least 90% of the nanoparticles have a particle size within this range. Methods of preparing, and using such catalyst compositions as well as catalyst articles and emission treatment systems comprising such catalyst compositions are also provided herein.

### FIELD OF THE INVENTION

The present invention relates to catalyst compositions comprising platinum group metal nanoparticles for emission treatment systems and to methods of making such catalyst compositions. Also provided are methods for reducing contaminants in exhaust gas streams, such as methods for treating exhaust hydrocarbon and NOₓ emissions from automotive engines.

### BACKGROUND OF THE INVENTION

Platinum group metals (PGMs) are a common component of catalyst compositions (e.g., three-way conversion (TWC) catalyst compositions) and can be incorporated therein in various forms. For example, certain catalyst compositions incorporate PGMs in the form of particles (e.g., nanoparticles). See U. A. Paulus, T. J. Schmidt, H. A. Gasteiger, R. J. Behm, J. Electroanal. Chem., 134, 495 (2001); J. W. Yoo, D. J. Hathcock, M. A. El-Sayed, J. Catalysis, 214, 1-7 (2003) and P. K. Jain, X. Huaung, M. A. Ei-Sayed, Acc. Chem. Res., 41, 1578-1586 (2008). For example, platinum (Pt) nanoparticles with controlled size and shape provide great opportunities for developing high-performance industrial Pt catalysts. See M. Q. Zhao, R. M. Crooks, Adv. Mater., 11, 217-220 (1999); M. Oishi, N. Miyagawa, T. Sakura, Y. Nagasaki, React. Funct. Polym. 67, 662-668 (2007) and K. Peng, X. Wang, X. Wu, S. Lee, Nano Lett., 9, 3704-3709 (2009).

Where platinum group metals are incorporated within a catalyst composition in the form of particles (e.g., nanoparticles), particle growth at elevated temperature, leading to a decrease in surface area, is a primary deactivation route for the catalyst composition. Accordingly, it would be advantageous to provide a catalyst composition comprising PGMs that is not as susceptible to such surface area loss, to allow for continued high catalytic efficiency under high temperature conditions of use. There is a continuing need to provide TWC catalyst compositions that utilize metals (e.g., PGMs) efficiently and remain effective to meet regulated HC, NOx, and CO conversions, particularly under such high temperature conditions.

### SUMMARY OF THE INVENTION

In one aspect, the present disclosure provides a catalyst composition comprising nanoparticles of one or more platinum group metals (PGMs). The PGMs, in certain embodiments, are selected from the group consisting of Pt, Pd, Au, Rh, alloys thereof, and mixtures thereof. In such catalyst compositions, the nanoparticles are generally associated with a refractory metal oxide support and provide, as will be disclosed herein, effective three-way conversion (TWC) catalytic activity.

In one aspect, the disclosure provides a three-way conversion catalyst composition comprising: a plurality of platinum group metal (PGM) nanoparticles selected from the group consisting of nanoparticles of Pt, Pd, Au, Rh, alloys thereof, and mixtures thereof, wherein the nanoparticles have an average particle size of 15 to 50 nm, wherein the nanoparticles are dispersed on a refractory metal oxide component, and wherein the catalyst composition is in calcined form and is effective for carrying out three-way conversion. In another aspect, the disclosure provides a three-way conversion catalyst composition comprising: a plurality of platinum group metal (PGM) nanoparticles selected from the group consisting of nanoparticles of Pt, Pd, Au, Rh, alloys thereof, and mixtures thereof, wherein the nanoparticles have an average particle size of 15 to 50 nm and at least 90% of the nanoparticles have a particle size within this range, wherein the nanoparticles are dispersed on a refractory metal oxide component, and wherein the catalyst composition is in calcined form and is effective for carrying out three-way conversion. The average particle sizes in such aspects are, in some embodiments, average particle sizes after calcination (e.g., after heat treatment in air at a temperature of about 400-550° C. for about 1-3 hours). Such average particle sizes are generally the average particle sizes prior to aging, i.e., wherein the compositions have not been subjected to aging conditions (e.g., treatment in steam/air at high temperature, such as at greater than about 700, greater than about 800, greater than about 900, or greater than about 1000° C. for at least about 3 hours).

In some embodiments, the plurality of PGM nanoparticles comprises a plurality of Pt nanoparticles, Pd nanoparticles, Rh nanoparticles, or a combination thereof. In some embodiments, the refractory metal oxide component is selected from the group consisting of activated alumina, lanthana-alumina, lanthana-zirconia, baria-alumina, ceria-alumina, ceria-lanthana-alumina, zirconia-alumina, ceria-zirconia ceria-zirconia-alumina, and combinations thereof. Certain exemplary embodiments include, but are not limited to, catalyst compositions wherein the PGM nanoparticles comprise palladium nanoparticles and the refractory metal oxide component comprises alumina and catalyst compositions wherein the PGM nanoparticles comprise palladium nanoparticles and the refractory metal oxide component comprises ceria-zirconia.

The sizes of the PGM nanoparticles can vary and in some embodiments, the PGM nanoparticles have an average particle size of 15 to 40 nm. In some embodiments, the PGM nanoparticles have an average particle size of 20 to 50 nm or 20 to 40 nm. In some embodiments, at least 95% of the nanoparticles have a particle size within a given particle size range (e.g., 15 to 50 nm, 15 to 40 nm, 20 to 50 nm, or 20 to 40 nm, respectively). In some embodiments, at least 95% of the PGM nanoparticles have a particle size of within 50 percent of the average particle size.

The disclosure, in some aspects, further provides a catalyst article comprising a catalyst substrate having a plurality of channels adapted for gas flow, each channel having a coating thereon, the coating comprising a three-way conversion catalyst composition as disclosed herein. The substrate can vary and, in some embodiments, is a metal or ceramic honeycomb substrate. The substrate, in some embodiments, is a wall flow filter or a flow through substrate.

In certain embodiments, the three-way conversion catalyst composition is present on the substrate in a loading of at least about 0.5 g/in³ or 1.0 g/in³. The coating may, in some embodiments, comprise a single layer comprising the three-way conversion catalyst composition. In other embodiments, the coating comprises two or more layers and wherein a top or bottom layer of the coating comprises the three-way conversion catalyst composition. The three-way conversion catalyst composition in some embodiments is zoned on one or both ends of the catalyst substrate such that the three-way conversion catalyst composition extends less than the full length of the catalyst substrate. The catalyst article in certain embodiments further comprises a second catalyst composition comprising one or more platinum group metals impregnated on a second refractory metal oxide component by traditional impregnation methods. In some embodiments, such three-way conversion catalyst composition and second catalyst composition are in admixture. In some embodiments, such three-way conversion catalyst and second catalyst composition are layered.

In another aspect, the disclosure provides an exhaust gas treatment system comprising the catalyst article disclosed herein, downstream of an automotive engine.

In a further aspect, the disclosure provides a method of making a three-way conversion catalyst composition, comprising: a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds; b) combining the solution with a reducing agent to provide PGM nanoparticles; c) dispersing the PGM nanoparticles on a refractory metal oxide support to provide supported PGM nanoparticles; and calcining the supported PGM nanoparticles. The disclosure additionally provides a method of making a three-way conversion catalyst composition, comprising: a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds; b) combining the solution with a refractory metal oxide support and a reducing agent to provide supported PGM nanoparticles comprising the PGM nanoparticles dispersed on the refractory metal oxide support; and c) calcining the supported PGM nanoparticles.

In some embodiments, the PGM precursors are salts of Pt, Pd, or alloys thereof. Exemplary platinum group metal precursors include, but are not limited to, precursors selected from the group consisting of alkanolamine salts, hydroxy salts, nitrates, carboxylic acid salts, ammonium salts, and oxides. The solid support material in certain embodiments is selected from the group consisting activated alumina, lanthana-alumina, lanthana-zirconia, baria-alumina, ceria-alumina, ceria-lanthana-alumina, zirconia-alumina, ceria-zirconia ceria-zirconia-alumina, and combinations thereof.

The disclosure further provides, in another aspect, a method for treating an exhaust gas comprising hydrocarbons, carbon monoxide, and nitrogen oxides comprising: contacting the exhaust gas with a three-way conversion catalyst composition as generally disclosed herein.

The present disclosure includes, without limitation, the following embodiments.

Embodiment 1: A three-way conversion catalyst composition comprising: a plurality of platinum group metal (PGM) nanoparticles selected from the group consisting of nanoparticles of Pt, Pd, Au, Rh, alloys thereof, and mixtures thereof, wherein the nanoparticles have an average particle size of 15 to 50 nm, wherein the nanoparticles are dispersed on a refractory metal oxide component, and wherein the catalyst composition is in calcined form and is effective for carrying out three-way conversion.

Embodiment 2: A three-way conversion catalyst composition comprising: a plurality of platinum group metal (PGM) nanoparticles selected from the group consisting of nanoparticles of Pt, Pd, Au, Rh, alloys thereof, and mixtures thereof, wherein the nanoparticles have an average calcined particle size of 15 to 50 nm and at least 90% of the nanoparticles have a particle size within this range, wherein the nanoparticles are dispersed on a refractory metal oxide component, and wherein the catalyst composition is in calcined form and is effective for carrying out three-way conversion.

Embodiment 3: The three-way conversion catalyst composition of any preceding embodiment, wherein the plurality of PGM nanoparticles comprises a plurality of Pt nanoparticles, Pd nanoparticles, Rh nanoparticles, or a combination thereof.

Embodiment 4: The three-way conversion catalyst composition of any preceding embodiment, wherein the refractory metal oxide component is selected from the group consisting of activated alumina, lanthana-alumina, lanthana-zirconia, baria-alumina, ceria-alumina, ceria-lanthana-alumina, zirconia-alumina, ceria-zirconia ceria-zirconia-alumina, and combinations thereof.

Embodiment 5: The three-way conversion catalyst composition of any preceding embodiment, wherein the PGM nanoparticles comprise palladium nanoparticles and the refractory metal oxide component comprises alumina.

Embodiment 6: The three-way conversion catalyst composition of any preceding embodiment, wherein the PGM nanoparticles comprise palladium nanoparticles and the refractory metal oxide component comprises ceria-zirconia.

Embodiment 7: The three-way conversion catalyst composition of any preceding embodiment, wherein the PGM nanoparticles have an average particle size of 20 to 40 nm.

Embodiment 8: The three-way conversion catalyst composition of any preceding embodiment, herein at least 95% of the nanoparticles have a particle size of 15 to 50 nm.

Embodiment 9: The three-way conversion catalyst composition of any preceding embodiment, wherein at least 95% of the PGM nanoparticles have a particle size of within 50 percent of the average particle size.

Embodiment 10: The three-way conversion catalyst composition of any preceding embodiment, wherein the nanoparticles have not been subjected to aging conditions.

Embodiment 11: The three-way conversion catalyst composition of any preceding embodiment, wherein the nanoparticles have not been subjected to heat treatment at temperatures at or above 1000° C.

Embodiment 12: A catalyst article comprising a catalyst substrate having a plurality of channels adapted for gas flow, each channel having a coating thereon, the coating comprising the three-way conversion catalyst composition of any preceding embodiment.

Embodiment 13: The catalyst article of the preceding embodiment, wherein the catalyst substrate is a metal or ceramic honeycomb substrate.

Embodiment 14: The catalyst article of any preceding embodiment, wherein the catalyst substrate is a wall flow filter or a flow through substrate.

Embodiment 15: The catalyst article of any preceding embodiment, wherein the three-way conversion catalyst composition is present on the catalyst substrate in a loading of at least about 0.5 g/in³or 1.0 g/in³.

Embodiment 16: The catalyst article of any preceding embodiment, wherein the coating comprises a single layer comprising the three-way conversion catalyst composition.

Embodiment 17: The catalyst article of any preceding embodiment, wherein the coating comprises two or more layers and wherein a top or bottom layer of the coating comprises the three-way conversion catalyst composition.

Embodiment 18: The catalyst article of any preceding embodiment, wherein the three-way conversion catalyst composition is zoned on one or both ends of the catalyst substrate such that the three-way conversion catalyst composition extends less than the full length of the catalyst substrate.

Embodiment 19: The catalyst article of any preceding embodiment, further comprising a second catalyst composition comprising one or more platinum group metals impregnated on a second refractory metal oxide component by traditional impregnation methods.

Embodiment 20: The catalyst article of any preceding embodiment, wherein the three-way conversion catalyst composition and the second catalyst composition are in admixture.

Embodiment 21: The catalyst article of any preceding embodiment, wherein the three-way conversion catalyst and the second catalyst composition are layered.

Embodiment 22: An exhaust gas treatment system comprising the catalyst article of any preceding embodiment, positioned downstream of an automotive engine.

Embodiment 23: A method of making the three-way conversion catalyst composition of any preceding embodiment, comprising: a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds; b) combining the solution with a reducing agent to provide PGM nanoparticles; c) dispersing the PGM nanoparticles on a refractory metal oxide support to provide supported PGM nanoparticles; and d) calcining the supported PGM nanoparticles.

Embodiment 24: A method of making the three-way conversion catalyst of any preceding embodiment, comprising: a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds; b) combining the solution with a refractory metal oxide support and a reducing agent to provide supported PGM nanoparticles comprising the PGM nanoparticles dispersed on the refractory metal oxide support; and c) calcining the supported PGM nanoparticles.

Embodiment 25: The method of any preceding embodiment, wherein the PGM precursors are salts of Pt, Pd, or alloys thereof.

Embodiment 26: The method of any preceding embodiment, wherein the platinum group metal precursors are selected from the group consisting of alkanolamine salts, hydroxy salts, nitrates, carboxylic acid salts, ammonium salts, and oxides.

Embodiment 27: The method of any preceding embodiment, wherein the solid support material is selected from the group consisting activated alumina, lanthana-alumina, lanthana-zirconia, baria-alumina, ceria-alumina, ceria-lanthana-alumina, zirconia-alumina, ceria-zirconia ceria-zirconia-alumina, and combinations thereof.

Embodiment 28: A method for treating an exhaust gas comprising hydrocarbons, carbon monoxide, and nitrogen oxides comprising: contacting the exhaust gas with the three-way conversion catalyst composition of any preceding embodiment. These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present invention will become apparent from the following.

### BRIEF DESCRIPTION OF THE DRAWINGS

FIG. 1A is a perspective view of a honeycomb-type substrate which may comprise a diesel oxidation catalyst (DOC) washcoat composition in accordance with the present invention;

FIG. 1B is a partial cross-sectional view enlarged relative to FIG. 1A and taken along a plane parallel to the end faces of the carrier of FIG. 1A, which shows an enlarged view of a plurality of the gas flow passages shown in FIG. 1A;

FIGS. 2A and 2B are transmission electron microscopy (TEM) images of: (A) a calcined (fresh) catalyst composition comprising conventional Pd-impregnated alumina; and (B) a calcined (fresh) catalyst composition comprising Pd nanoparticles on an alumina support;

FIGS. 3A and 3B are transmission electron microscopy (TEM) images of: (A) an aged catalyst composition comprising conventional Pd-impregnated alumina; and (B) an aged catalyst composition comprising Pd nanoparticles on an alumina support;

FIG. 4 is a graph of NOₓ conversion over time for a PGM nanoparticle-containing composition as disclosed herein as compared with a conventional PGM-impregnated material;

FIGS. 5A and 5B are graphs of NOₓ conversion over time for a PGM nanoparticle-containing composition as disclosed herein as compared with a conventional PGM-impregnated material using two different protocols; and

FIGS. 5C and 5D are graphs of CO₂ formation over time for a PGM nanoparticle-containing composition as disclosed herein as compared with a conventional PGM-impregnated material using two different protocols.

### DETAILED DESCRIPTION OF THE PREFERRED EMBODIMENTS

Before describing several exemplary embodiments of the invention, it is to be understood that the invention is not limited to the details of construction or process steps set forth in the following description. The invention is capable of other embodiments and of being practiced or being carried out in various ways.

The present disclosure describes catalyst compositions comprising platinum group metal (PGM) nanoparticles. In some such embodiments, three-way conversion (TWC) catalysts are disclosed, comprising one or more PGM nanoparticles dispersed on a support material, e.g., a refractory metal oxide support material. The support is then generally coated on a suitable substrate, such as a monolithic substrate, e.g., a flow through substrate or a wall-flow filter. TWC catalyst compositions can optionally be formulated to include an oxygen storage component (OSC) (e.g., a component comprising ceria and/or praseodymia).

In particular, the disclosure provides compositions comprising PGM nanoparticles with a substantially uniform particle size distribution, as will be described in further detail herein below. By providing PGMs in nanoparticle form with substantially uniform particle sizes and associating such PGM nanoparticles with support materials, catalyst compositions are provided wherein particle sintering during thermal aging at high temperatures is minimized, leading to higher hydrocarbon (HC) oxidation and NOx reduction in three-way conversion (TWC) catalyst applications (as compared with, e.g., traditional PGM-impregnated support materials).

The phenomenon of particle sintering, e.g., within PGM-containing catalyst compositions, is believed to proceed by one of two limiting mechanisms, namely, Ostwald ripening (OR) or particle migration and coalescence (PMC). See, e.g., Hansen et al. Acc. Chem. Res. 2013, 46(8): 1720-30, which is incorporated herein by reference. Under the OR mechanism, it is assumed that metal particles are immobile and sintering occurs solely due to the migration of atoms or clusters from small particles to large particles. Under the PMC sintering mechanism, particles are understood to be mobile in a Brownian-like motion on the support surface, with subsequent coalescence leading to nanoparticle growth. The catalytic compositions disclosed herein address both proposed mechanisms by providing PGM particles with a defined initial particle size with narrow particle size distribution (impacting the OR mechanism) and PGM particles associated with a support material so as to minimize migration (impacting the proposed PMC mechanism). As such, the materials disclosed herein exhibit decreased sintering at high temperatures as compared with other PGM particle-containing compositions.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The articles “a” and “an” are used herein to refer to one or to more than one (i.e., to at least one) of the grammatical object of the article. By way of example, “a reducing agent” means one reducing agent or more than one reducing agent. Any ranges cited herein are inclusive. The term “about” used throughout this specification are used to describe and account for small fluctuations. For example, the term “about” can refer to less than or equal to ±5%, such as less than or equal to ±2%, less than or equal to ±1%, less than or equal to ±0.5%, less than or equal to ±0.2%, less than or equal to ±0.1% or less than or equal to ±0.05%. A value modified by the term “about” of course includes the specific value. For instance, “about 5.0” must include 5.0. All measurements herein are performed at ambient conditions, 25° C. and 1 atm of pressure, unless otherwise indicated.

The following definitions are used herein.

As used herein, “impregnated” or “impregnation” refers to permeation of catalytic material into the porous structure of a support material.

As used herein, the term “average particle size” refers to a characteristic of particles that indicates, on average, the diameter of the particles. In some embodiments, such an average particle size can be measured by transmission electron microscopy (TEM). As described herein, the “average particle sizes” referred to in certain embodiments are average particle sizes of fresh/calcined material, e.g., determined after calcination of the particles, but prior to aging of the particles.

As used herein, the term “washcoat” is a thin, adherent coating of a catalytic or other material applied to a refractory substrate, such as a honeycomb flow-through monolith substrate or a filter substrate, which is sufficiently porous to permit the passage therethrough of the gas stream being treated. A “washcoat layer,” therefore, is defined as a coating that is comprised of support particles and can be applied either outside of the wall of the substrate (e.g. flow-through monolith substrate) or inside the pores of the wall of the substrate (e.g. filters). A “catalyzed washcoat layer” is a coating comprised of support particles associated with catalytic components (e.g., comprised of PGM nanoparticles dispersed on refractory metal oxide support particles, as provided herein).

As used herein, the term “catalytic article” refers to an element that is used to promote a desired reaction. For example, a catalytic article may comprise a washcoat containing catalytic compositions on a substrate.

The terms “upstream” and “downstream” refer to relative directions according to the flow of an engine exhaust gas stream from an engine towards a tailpipe, with the engine in an upstream location and the tailpipe and any pollution abatement articles such as catalysts and filters being downstream from the engine.

As used herein, the term “stream” broadly refers to any combination of flowing gas that may contain solid or liquid particulate matter. The term “gaseous stream” or “exhaust gas stream” means a stream of gaseous constituents, such as the exhaust of an internal combustion engine, which may contain entrained non-gaseous components such as liquid droplets, solid particulates, and the like. The exhaust gas stream of an internal combustion engine typically further comprises combustion products, products of incomplete combustion, oxides of nitrogen, oxides of sulfur, combustible and/or carbonaceous particulate matter (soot), and un-reacted oxygen and nitrogen.

The term “abatement” means a decrease in the amount, caused by any means.

### PGM Nanoparticles

Catalyst compositions disclosed herein generally comprise nanoparticles of platinum group metals (PGMs). “PGM,” as used herein, means a metal selected from the group consisting of platinum (Pt), palladium (Pd), gold (Au), silver (Ag), ruthenium (Ru), rhodium (Rh), iridium (Ir), osmium (Os), and combinations and alloys thereof. In certain embodiments, the nanoparticles of PGMs comprise Pd as the sole PGM. In some embodiments, the nanoparticles comprise Pd nanoparticles in combination with Pt, Rh, and/or Ir nanoparticles. In other embodiments, the nanoparticles comprise Pt nanoparticles, alone or in combination with, e.g., Rh nanoparticles. Typically, the PGM nanoparticles disclosed herein independently comprise a single type of PGM in a given nanoparticle. However, in some embodiments, mixed PGM nanoparticles can be provided, wherein a given nanoparticle can comprise more than one PGM (e.g., Pt and Pd).

Advantageously, the PGM(s) in such nanoparticles is substantially in fully reduced form, meaning that at least about 90% of the PGM content is reduced to the metallic form (PGM(0)). In some embodiments, the amount of PGM in fully reduced form is even higher, e.g., at least about 92%, at least about 94%, at least about 95%, at least about 96%, at least about 97%, at least about 98%, or at least about 99% of the PGM is in fully reduced form. The amount of PGM(0) can be determined using ultrafiltration, followed by Inductively Coupled Plasma/Optical Emission Spectrometry (ICP-OES).

The average size of the PGM nanoparticles in the catalyst compositions disclosed herein can vary. In some embodiments, the PGM nanoparticles in a given catalyst composition can have average particle sizes (in fresh/calcined form) of about 5 nm to about 50 nm, e.g., about 10 nm to about 50 nm, about 15 to about 50 nm, or about 15 to about 40 nm, such as an average particle size of about 5 nm, about 10 nm, about 15 nm, about 20 nm, about 25 nm, about 30 nm, about 35 nm, about 40 nm, about 45 nm, or about 50 nm. Certain embodiments can have average particle sizes (in fresh/calcined form) of about 5-30 nm, about 5-20 nm, about 5-15 nm, about 10-50 nm, about 10-25 nm, about 15-50 nm, about 15-40 nm, about 15-30 nm, about 20-50 nm, about 20-40 nm, about 20-30 nm, or about 25-50 nm. In some embodiments, such particle size ranges describe PGM nanoparticles in catalyst compositions that have not been aged (e.g., which have not been subjected to temperatures greater than about 700° C., 800° C., 900° C., or 1000° C.).

Advantageously, the PGM nanoparticles in the catalyst compositions disclosed herein are substantially monodisperse with respect to particle size. In certain embodiments, the particles can be viewed as monodisperse, meaning the nanoparticle population is highly uniform in particle size. Certain monodisperse particle populations useful in the present invention can be characterized as consisting of particles wherein at least 90% of the particles have a particle size within 50 percent of the average particle size for the particle population, or within 20 percent, or within 15 percent, within 10 percent, or within 5 percent (i.e., wherein at least 90% of all particles in the population have a particle size within the given percentage range around the average particle size). In other embodiments, at least 95%, 96%, 97%, 98%, or 99% of all particles fall within these ranges. In one exemplary embodiment, the average particle size is about 25 nm and at least 90% of all particles (or at least 95%, 96%, 97%, 98%, 99%, or 100%) of all particles in the population have a particle size in the range of about 12.5 nm to about 37.5 nm (i.e., within about 50 percent of the average particle size). In some embodiments, the average particle size is about 25 nm and at least 90% of all particles (or at least 95%, 96%, 97%, 98%, 99%, or 100%) of all particles in the population have a particle size in the range of about 18.75 nm to about 31.25 nm (i.e., within about 25 percent of the average particle size). In some embodiments, the average particle size is about 25 nm and at least 90% of all particles (or at least 95%, 96%, 97%, 98%, 99%, or 100%) of all particles in the population have a particle size in the range of about 22.5 nm to about 27.5 nm (i.e., within about 10 percent of the average particle size). Specific PGM nanoparticle samples for use herein are substantially monodisperse, with average PGM nanoparticle sizes of about 20 nm, about 25 nm, about 30 nm, about 35 nm, and about 40 nm.

Particle sizes and size distributions of PGM nanoparticles can be determined using Transmission Electron Microscopy (TEM). Such TEM evaluations can be done based, e.g., on calcined supported PGM nanoparticles (e.g., as shown in the Figures). Such values can be found by visually examining a TEM image, measuring the diameter of the particles in the image, and calculating the average particle size of the measured particles based on magnification of the TEM image. The particle size of a particle refers to the smallest diameter sphere that will completely enclose the particle, and this measurement relates to an individual particle as opposed to an agglomeration of two or more particles. The above-noted size ranges are average values for particles having a distribution of sizes. Distributions of particle sizes and percentages of particles having sizes within a particular range can be determined, e.g., from TEM or Scanning Electron Microscopy (SEM) by coating calcined supported PGM nanoparticles onto a substrate. The calcined supported PGM nanoparticles on the substrate can be directly analyzed by TEM or SEM (looking at the coated substrate) or can be analyzed by scraping or otherwise removing at least a portion of the calcined supported PGM nanoparticles from the substrate and obtaining an image of the scraped/removed supported PGM nanoparticles.

In certain embodiments, the PGM nanoparticles disclosed herein are provided in a form that is substantially free of halides, alkali metals, alkaline earth metals, and sulfur compounds. For example, the nanoparticles may comprise less than about 10 ppm of each such component (i.e., less than about 10 ppm halides, alkali metals, alkaline earth metals, and/or sulfur compounds) based on the total weight of the PGM nanoparticles. Particularly, it is desirable for the halide (e.g., chloride, bromide, and iodide) content to be less than about 10 ppm and for the sodium content to be less than about 10 ppm based on the total weight of the PGM nanoparticles. Even lower concentrations of such components are even more desirable, e.g., less than about 5 ppm, less than about 2 ppm, or less than about 1 ppm based on the total weight of the PGM nanoparticles.

### Catalyst Compositions

The present disclosure provides catalyst compositions comprising PGM nanoparticles as described herein above. In some embodiments, such catalyst compositions are provided wherein the sole PGM source in the composition is the PGM nanoparticles. In other embodiments, such catalyst compositions may comprise one or more additional PGM sources (wherein the PGM(s) provided by such additional PGM source(s) can be the same or different than the PGM(s) of the PGM nanoparticles).

For such catalytic applications, the PGM nanoparticles disclosed herein may be deposited on a solid catalyst support material, e.g., on a refractory metal oxide support. The concentration of PGM nanoparticles within a catalyst composition can vary, but will typically be from about 0.1 wt. % to about 10 wt. % relative to the weight of the support material with PGM nanoparticles deposited thereon (e.g., about 1 wt. % to about 6 wt. % relative to such materials) in a given composition. In some embodiments, the concentration of the PGM nanoparticles can be about 2 wt. % to about 4 wt. %, based on the total weight of the weight of the support material with PGM nanoparticles deposited thereon.

As used herein, “refractory metal oxide” refers to a metal-containing oxide support exhibiting chemical and physical stability at high temperatures, such as the temperatures associated with gasoline and diesel engine exhaust. Exemplary refractory metal oxides include alumina, silica, zirconia, titania, ceria, and physical mixtures or chemical combinations thereof, including atomically-doped combinations. In some embodiments, a “refractory metal oxide” is modified with a metal oxide(s) of alkali, semimetal, and/or transition metal, e.g., La, Mg, Ba, Sr, Zr, Ti, Si, Ce, Mn, Nd, Pr, Sm, Nb, W, Mo, Fe, or combinations thereof. In some embodiments, the amount of metal oxide(s) used to modify the “refractory metal oxide” can range from about 0.5% to about 50% by weight based on the amount of “refractory metal oxide.” Exemplary combinations of metal oxides include alumina-zirconia, ceria-zirconia, alumina-ceria-zirconia, lanthana-alumina, lanthana-zirconia, lanthana-zirconia-alumina, baria-alumina, baria lanthana-alumina, baria lanthana-neodymia alumina, and alumina-ceria.

In some embodiments, high surface area refractory metal oxide supports are used, such as alumina support materials, also referred to as “gamma alumina” or “activated alumina,” typically exhibit a BET surface area in excess of 60 m²/g, often up to about 200 m²/g or higher. “BET surface area” has its usual meaning of referring to the Brunauer, Emmett, Teller method for determining surface area by N₂ adsorption. In one or more embodiments the BET surface area ranges from about 100 to about 150 m²/g. Useful commercial alumina include high surface area alumina, such as high bulk density gamma-alumina, and low or medium bulk density large pore gamma-alumina.

In some embodiments, a refractory metal oxide support comprises an oxygen storage component. As used herein, “OSC” refers to an oxygen storage component, that exhibits an oxygen storage capability and often is an entity that has multi-valent oxidation states and can actively release oxygen under an oxygen depleted environment and be re-oxidized (restore oxygen) under an oxygen enriched environment. Examples of suitable oxygen storage components include ceria and praseodymia and combinations thereof.

In some embodiments, the OSC is a mixed metal oxide composite, comprising ceria and/or praseodymia in combination with other metal oxides. Certain metal oxides that can be included in such mixed metal oxides include but are not limited to zirconium oxide (ZrO₂), titania (TiO₂), yttria (Y₂O₃), neodymia (Nd₂O₃), lanthana (La₂O₃), or mixtures thereof. For example, a “ceria-zirconia composite” means a composite comprising ceria and zirconia. In some embodiments, the ceria content in a mixed metal oxide composite ranges from about 25% to about 95%, preferably from about 50% to about 90%, more preferably from about 60% to about 70% by weight of the total mixed metal oxide composite (e.g., at least about 25% or at least about 30% or at least about 40% ceria content). In some embodiments, the total ceria or praseodymia content in the OSC ranges from about 5% to about 99.9%, preferably from about 5% to about 70%, more preferably from about 10% to about 50% by weight of the total mixed metal oxide composite.

### Method of Making PGM Nanoparticle-Containing Catalyst Composition

Catalyst compositions disclosed herein generally comprise one or more types of PGM nanoparticles associated with one or more types of support material, e.g., refractory metal oxide supports. As outlined herein below, the association can be achieved during production of the PGM nanoparticles (A) and/or after production of the PGM nanoparticles (B).

A. Preparation of PGM Nanoparticles with Dispersion on Support Material

In one embodiment, PGM nanoparticles can be associated with refractory metal oxide support materials during production of the PGM nanoparticles. One exemplary method for producing PGM nanoparticles is described in International Application Publication No. WO2016/057692 to BASF Corp., which is incorporated herein by reference in its entirety). Briefly, as disclosed therein, PGM precursors (e.g., salts of PGMS) are combined with a dispersion medium and a polymer suspension stabilizing agent and the resulting solution is combined with a reducing agent to provide a PGM nanoparticle colloidal dispersion. To provide PGM nanoparticles associated with a refractory metal oxide support, the refractory metal oxide support material can be added to the dispersion in which PGM nanoparticles are formed at any stage of the process (e.g., along with the PGM precursors or along with the reducing agent) to disperse the nanoparticles on the refractory metal oxide support material.

### B. Preparation of PGM Nanoparticles and Subsequent Dispersion on Support Material

In some embodiments, nanoparticles are prepared, e.g., by the methods outlined in International Application Publication No. WO2016/057692 to BASF Corp., which is incorporated herein by reference in its entirety (and referenced above), which describes the production of a nanoparticle dispersion. In some embodiments, a refractory metal oxide support material is added directly to this PGM nanoparticle dispersion to disperse the nanoparticles on the refractory metal oxide support material. Prior this addition, the dispersion of PGM nanoparticles can be optionally concentrated or diluted.

In other embodiments, the nanoparticles are isolated and subsequently associated with the refractory metal support material. Methods for isolating particles from a dispersion generally are known and, in some embodiments, isolated PGM nanoparticles can be obtained by heating and/or applying vacuum to a dispersion containing nanoparticles or otherwise processing the dispersion to ensure removal of at least a substantial portion of the solvent therefrom. Following isolation of the PGM nanoparticles, the PGM nanoparticles and the refractory metal oxide support can be mixed (e.g., with water) to form a dispersion wherein the PGM nanoparticles can be dispersed on the refractory metal oxide support material. Such methods, providing for association with a refractory metal oxide support material after the PGM nanoparticles are formed, are commonly described as incipient wetness techniques. This process may be repeated several times to achieve target PGM concentration on the support.

### C. Calcining

The catalyst composition (prepared according to A or B above) is then dried and calcined to drive off volatile components. These processes can comprise heat treating at elevated temperature (e.g., 100-150° C.) for a period of time (e.g., 1-3 hours), and then calcining to convert the metal components to a more catalytically active form. An exemplary calcination process involves heat treatment in air at a temperature of about 400-550° C. for 1-3 hours. The above process can be repeated as needed to reach the desired level of impregnation.

The resulting material typically comprises PGM nanoparticles dispersed on internal pores and external surfaces of the support material. Catalytic compositions incorporating such PGM nanoparticles have been demonstrated to exhibit significantly higher PGM dispersion within the support material (via CO chemisorption) and have also been demonstrated to exhibit significantly higher surface PGM concentration (via x-ray photoelectron spectroscopy). The material can be stored as a dry powder or in slurry form. This material typically has the particle size ranges referenced herein above, e.g., an average particle size of about 5 nm to about 50 nm, about 10 nm to about 50 nm, about 15 to about 50 nm, or about 15 to about 40 nm.

One aspect of the invention is the recognition that the calcined catalyst compositions of the invention exhibit an average PGM nanoparticle diameter after calcining that does not increase after aging as significantly as the average diameter of PGM particles arising from typical impregnation methods. For example, in some embodiments, the supported PGM nanoparticles disclosed herein may exhibit up to about a 5-fold increase, up to about a 3-fold increase, or up to about a 2-fold increase in particle diameter after aging (e.g., in 10% steam/air at 1050° C. for 5 hours), whereas PGM particles arising from typical impregnation methods may exhibit a 10-fold increase or greater after aging. As one example, a composition comprising PGM nanoparticles with an average diameter after calcining of about 20 nm can exhibit an average PGM nanoparticle diameter after aging (at the noted conditions) of up to about 100 nm, advantageously up to about 60 nm, or more advantageously up to about 40 nm.

### Substrate

According to one or more embodiments, the substrate for the PGM nanoparticle-containing composition may be constructed of any material typically used for preparing automotive catalysts and will typically comprise a metal or ceramic honeycomb structure. The substrate typically provides a plurality of wall surfaces upon which a PGM nanoparticle-containing washcoat composition is applied and adhered, thereby acting as a carrier for the catalyst composition.

Exemplary metallic substrates include heat resistant metals and metal alloys, such as titanium and stainless steel as well as other alloys in which iron is a substantial or major component. Such alloys may contain one or more of nickel, chromium, and/or aluminum, and the total amount of these metals may advantageously comprise at least 15 wt. % of the alloy, e.g., 10-25 wt. % of chromium, 3-8 wt. % of aluminum, and up to 20 wt. % of nickel. The alloys may also contain small or trace amounts of one or more other metals, such as manganese, copper, vanadium, titanium and the like. The surface of the metal carriers may be oxidized at high temperatures, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-α alumina, silicon nitride, zircon mullite, spodumene, alumina-silica magnesia, zircon silicate, sillimanite, magnesium silicates, zircon, petalite, α alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which can be of any suitable cross-sectional shape, such as trapezoidal, rectangular, square, sinusoidal, hexagonal, oval, circular, and the like. Such structures may contain from about 60 to about 1200 or more gas inlet openings (i.e., “cells”) per square inch of cross section (cpsi), more usually from about 300 to 600 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry.

In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used a wall-flow filter substrates. However, it will be understood that the invention is not limited to a particular substrate type, material, or geometry. Note that where the substrate is a wall-flow substrate, the catalyst composition associated therewith (e.g., comprising PGM nanoparticles as disclosed herein) can permeate into the pore structure of the porous walls (i.e., partially or fully occluding the pore openings) in addition to being disposed on the surface of the walls.

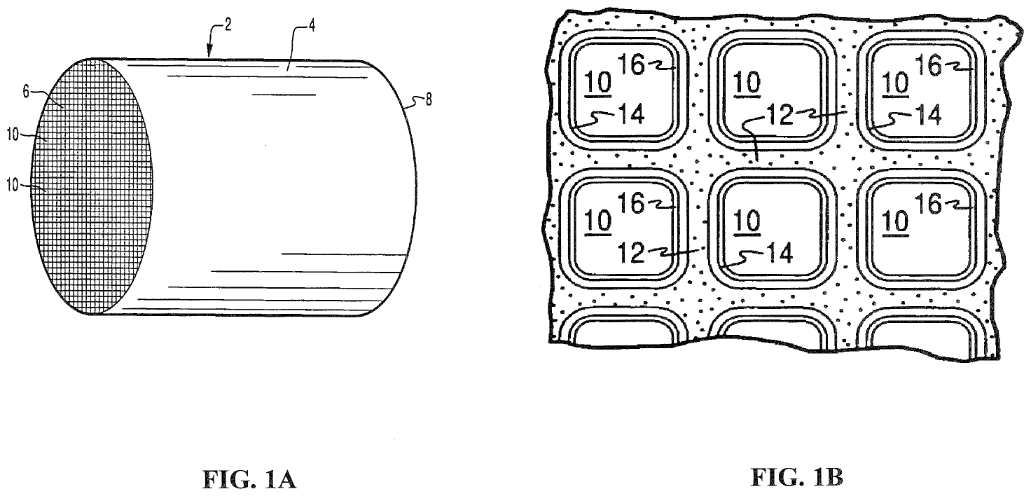

FIGS. 1A and 1B illustrate an exemplary substrate 2 in the form of a flow-through substrate coated with a washcoat composition as described herein. Referring to FIG. 1A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the washcoat composition can be applied in multiple, distinct layers if desired. In the illustrated embodiment, the washcoat consists of both a discrete bottom washcoat layer 14 adhered to the walls 12 of the carrier member and a second discrete top washcoat layer 16 coated over the bottom washcoat layer 14. The present invention can be practiced with one or more (e.g., 2, 3, or 4) washcoat layers and is not limited to the two-layer embodiment illustrated in FIG. 1B.

### Substrate Coating Process

As referenced above, the PGM nanoparticle-containing catalyst composition is prepared and coated on a substrate. This method can comprise mixing a catalyst composition as generally disclosed herein with a solvent (e.g., water) to form a slurry for purposes of coating a catalyst substrate. In addition to the catalyst composition (i.e., the PGM nanoparticles associated with a refractory metal oxide support), the slurry may optionally contain various additional components. Typical additional components include, but are not limited to, one or more binders and additives to control, e.g., pH and viscosity of the slurry. Particular additional components can include alumina as a binder, hydrocarbon (HC) storage components (e.g., zeolites), associative thickeners, and/or surfactants (including anionic, cationic, non-ionic or amphoteric surfactants).

Optionally, the slurry may contain one or more hydrocarbon (HC) storage component for the adsorption of hydrocarbons (HC). Any known hydrocarbon storage material can be used, e.g., a microporous material such as a zeolite or zeolite-like material. When present, zeolite or other HC storage components are typically used in an amount of about 0.05 g/in³ to about 1 g/in³. When present, an alumina binder is typically used in an amount of about 0.02 g/in³ to about 0.5 g/in³. The alumina binder can be, for example, boehmite, gamma-alumina, or delta/theta alumina.

The slurry can, in some embodiments be milled to enhance mixing of the particles and formation of a homogenous material. The milling can be accomplished in a ball mill, continuous mill, or other similar equipment, and the solids content of the slurry may be, e.g., about 20-60 wt. %, more particularly about 30-40 wt. %. In one embodiment, the post-milling slurry is characterized by a D90 particle size of about 10 to about 50 microns (e.g., about 10 to about 20 microns). The D90 is defined as the particle size at which about 90% of the particles have a finer particle size.

The slurry is generally coated on the catalyst substrate using a washcoat technique known in the art. As used herein, the term “washcoat” has its usual meaning in the art of a thin, adherent coating of a material (e.g., a catalytic material) applied to a substrate, such as a honeycomb flow-through monolith substrate or a filter substrate which is sufficiently porous to permit the passage therethrough of the gas stream being treated. As used herein and as described in Heck, Ronald and Robert Farrauto, Catalytic Air Pollution Control, New York: Wiley-Interscience, 2002, pp. 18-19, a washcoat layer includes a compositionally distinct layer of material disposed on the surface of a monolithic substrate or an underlying washcoat layer. A substrate can contain one or more washcoat layers, and each washcoat layer can have unique chemical catalytic functions.

A washcoat is generally formed by preparing a slurry containing a specified solids content (e.g., 30-90% by weight) of catalyst material (here, the PGM nanoparticles associated with refractory metal oxide supports) in a liquid vehicle, which is then coated onto the substrate (or substrates) and dried to provide a washcoat layer. To coat the wall flow substrates with the catalyst material of one or more embodiments, the substrates can be immersed vertically in a portion of the catalyst slurry such that the top of the substrate is located just above the surface of the slurry. In this manner, slurry contacts the inlet face of each honeycomb wall, but is prevented from contacting the outlet face of each wall. The sample is left in the slurry for about 30 seconds. The substrate is removed from the slurry, and excess slurry is removed from the wall flow substrate first by allowing it to drain from the channels, then by blowing with compressed air (against the direction of slurry penetration), and then by pulling a vacuum from the direction of slurry penetration. By using this technique, the catalyst slurry permeates the walls of the substrate, yet the pores are not occluded to the extent that undue back pressure will build up in the finished substrate. As used herein, the term “permeate” when used to describe the dispersion of the catalyst slurry on the substrate, means that the catalyst composition is dispersed throughout the wall of the substrate.

Thereafter, the coated substrate is dried at an elevated temperature (e.g., 100-150° C.) for a period of time (e.g., 1-3 hours) and then calcined by heating, e.g., at 400-600° C., typically for about 10 minutes to about 3 hours. Following drying and calcining, the final washcoat coating layer can be viewed as essentially solvent-free.

After calcining, the catalyst loading can be determined through calculation of the difference in coated and uncoated weights of the substrate. As will be apparent to those of skill in the art, the catalyst loading can be modified by altering the slurry rheology. In addition, the coating/drying/calcining process can be repeated as needed to build the coating to the desired loading level or thickness.

In describing the quantity of washcoat or catalytic metal components or other components of the composition, it is convenient to use units of weight of component per unit volume of catalyst substrate. Therefore, the units, grams per cubic inch (“g/in³”) and grams per cubic foot (“g/ft³”), are used herein to mean the weight of a component per volume of the substrate, including the volume of void spaces of the substrate. Other units of weight per volume such as g/L are also sometimes used. The total loading of the PGM nanoparticle-containing composition on the catalyst substrate, such as a monolithic flow-through substrate, is typically from about 0.5 to about 6 g/in³, and more typically from about 1 to about 5 g/in³. Total loading of the PGM nanoparticles without support material (e.g., the Pd) is typically in the range of about 5 to about 200 g/ft³ (e.g., about 5 to about 50 g/ft³ and, in certain embodiments, about 10 to about 50 g/ft³ or about 10 to about 100 g/ft³). It is noted that these weights per unit volume are typically calculated by weighing the catalyst substrate before and after treatment with the catalyst washcoat composition, and since the treatment process involves drying and calcining the catalyst substrate at high temperature, these weights represent an essentially solvent-free catalyst coating as essentially all of the water of the washcoat slurry has been removed.

The disclosed PGM nanoparticle-containing compositions can be employed in various catalyst article designs that are encompassed within the present disclosure. For example, catalyst articles may be provided which include a PGM nanoparticle-containing composition in a single layer or a multilayer washcoat on a substrate (where each layer of the multilayer washcoat may be the same or different). Such catalyst articles may optionally further comprise one or more other types of washcoat layers.

In one specific embodiment, a catalyst article is provided comprising a single PGM nanoparticle-containing washcoat layer on a substrate, wherein the washcoat layer comprises Pt nanoparticles only, Pd nanoparticles only, Rh nanoparticles only, or any combination thereof (i.e., Pt nanoparticles and Pd nanoparticles, Pt nanoparticles and Rh nanoparticles, Pd nanoparticles and Rh nanoparticles, or Pt nanoparticles, Pd nanoparticles, and Rh nanoparticles). In another specific embodiment, a catalyst article is provided comprising multiple washcoat layers on a substrate (i.e., two or more washcoat layers), wherein the PGM nanoparticle-containing composition (comprising Pt nanoparticles only, Pd nanoparticles only, Rh nanoparticles only, or any combination thereof (i.e., Pt nanoparticles and Pd nanoparticles, Pt nanoparticles and Rh nanoparticles, Pd nanoparticles and Rh nanoparticles, or Pt nanoparticles, Pd nanoparticles, and Rh nanoparticles) is present in the bottom layer or the top layer. In other embodiments, a catalyst article is provided comprising both a PGM nanoparticle-containing composition as disclosed herein and a traditional PGM-containing catalyst composition (prepared by standard impregnation techniques). Such compositions can be within the same layer (e.g., provided in admixture with one another) or can be provided in separate layers.

The disclosure relates to catalyst articles comprising washcoat layers as referenced herein above with various configurations on a substrate. For example, in some embodiments, catalyst compositions are present in an axially zoned configuration. For example, the same carrier is coated with a washcoat slurry of one catalyst composition (which can be a PGM nanoparticle-containing composition as disclosed herein or another type of catalyst composition) and a washcoat slurry of another catalyst composition (which can be a PGM nanoparticle-containing composition as disclosed herein or another type of catalyst composition), wherein each catalyst composition is different. In one embodiment, the front/inlet zone of the substrate and/or the back/outlet zone of the substrate is coated with a PGM nanoparticle-containing composition as disclosed herein. The relative lengths of different zones can vary and

### Emission Treatment System

The present invention also provides an emission treatment system that incorporates the catalyst compositions described herein. A catalyst article comprising the catalyst composition of the present invention (wherein the composition is present as a washcoat on a substrate) is typically used in an integrated emissions treatment system comprising one or more additional components for the treatment of exhaust gas emissions. The relative placement of the various components of the emission treatment system can be varied.

PGM nanoparticle-containing catalysts can, in some embodiments, be effective for three-way conversion (TWC) applications, light duty diesel applications, heavy duty diesel applications, lean gasoline direct injection, and lean NOx trap applications. The emission treatment system may, in some embodiments, further comprise a selective catalytic reduction (SCR) catalytic article. The treatment system can include further components, such as a hydrocarbon trap, ammonia oxidation (AMOx) materials, ammonia-generating catalysts, and NOx storage and/or trapping components (LNTs). The preceding list of components is merely illustrative and should not be taken as limiting the scope of the invention.

### EXAMPLES

### Comparative Example 1

### Preparation of 1% Pd on 4% La₂O₃/Al₂O₃

About 3.7 g of Pd nitrate solution (Pd concentration=27% by weight) is diluted in about 75 g of distilled water. Pd is impregnated on 4% La₂O₃/Al₂O₃ by slowly mixing the Pd nitrate solution and 100 grams of 4% La₂O₃ on alumina. The mixing is continued for about 15 minutes, after which time the material is dried at 100° C. and calcined at 550° C. for 2 hours.

### Comparative Example 2

### Preparation of 3% Pd on 4% La₂O₃/Al₂O₃

About 11.2 g of Pd nitrate solution (Pd concentration=27% by weight) is diluted in about 75 g of distilled water. Pd is impregnated on 4% La₂O₃/Al₂O₃ by slowly mixing the Pd nitrate solution and 100 grams of 4% La₂O₃ on alumina. The mixing is continued for about 15 minutes, after which time the material is dried at 100° C. and calcined at 550° C. for 2 hours.

### Example 3

### Preparation of 3% Nano Pd Particles on 4% La₂O₃/Al₂O₃

About 15 g polyvinylpyrrolidone PVP K30 is dissolved in 170 g distilled water and 30 g ethanol. The solution is heated to 80° C. with steady stirring. In a separate vessel, (NH₃)₄Pd(NO₃)₂-solution (4.605% Pd by weight) is dissolved in 95 mL distilled water. The Pd-containing solution is added slowly to the PVP solution (giving a combined solution temperature below 75° C.). The resulting combined solution is heated back to 80° C. and alumina (in an amount sufficient to give a final Pd concentration after calcination of about 3% by weight) is added. The resulting suspension is stirred at 80° C. for 3 minutes and then dried using a rotary evaporator at 50° C. at 10 mbar. The drying vessel is vented with nitrogen and the product is dried further in a vacuum drying oven at 125° C. and 10 mbar for 16 h. The dried material is then calcined at 540° C. under a nitrogen atmosphere for 1 hour. After cooling, the product is passivated by slowly exchanging the nitrogen with air, while ensuring that the product does not overheat (keeping the temperature<500° C.). The Pd in the calcined product was analyzed and determined to be 2.67% by weight.

### Example 4

### Transmission Electron Microscopy (TEM) Comparison of Calcined (Fresh) Materials

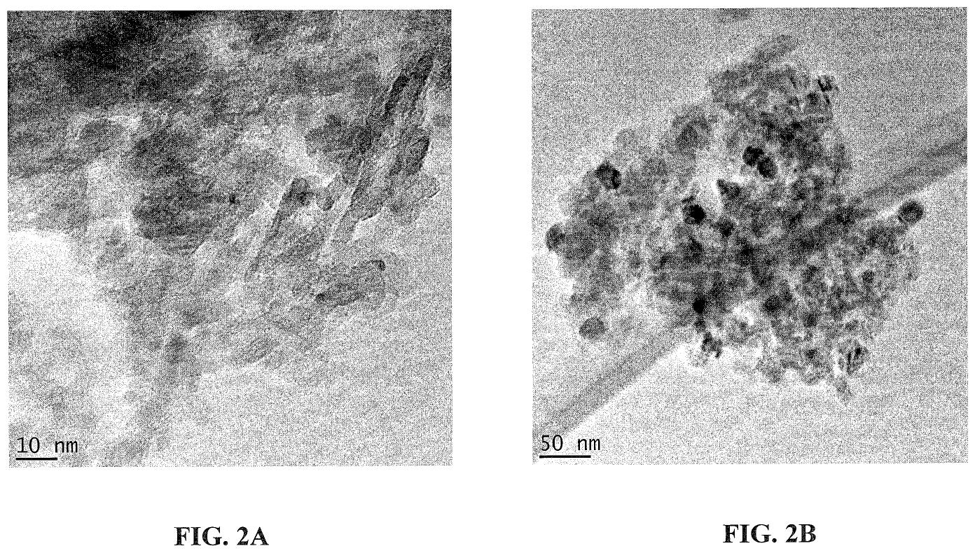

The Pd particles of Comparative Example 1 and Example 3 were compared and measured using TEM. The results showed that The Pd particles in the catalytic material of Example 3 are significantly bigger (with average diameter of about 20-25 nm) than the Pd particles of the comparative catalytic material of Example 1 (with average diameter of about 1 or 2 nm). These comparative images are provided in FIGS. 2A and 2B, with the comparative catalytic material of Example 1 represented as FIG. 2A and the catalytic material of Example 3 represented as FIG. 2B.

### Example 5

### Transmission Electron Microscopy (TEM) Comparison of Aged Materials

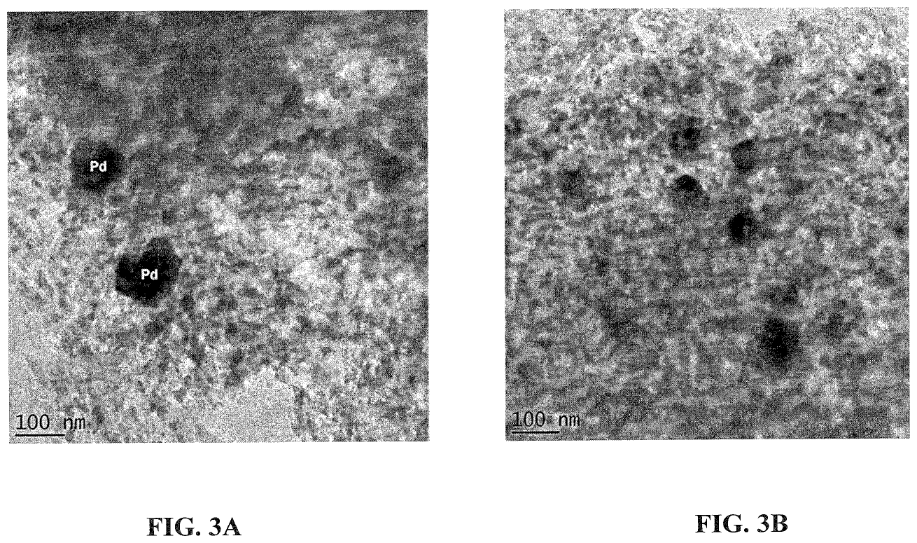

The Pd particles of Comparative Example 1 and Example 3 were then compared and measured using TEM after aging in 10% steam/air at 1050° C. for 5 hours. The results show that the Pd particles in the catalyst composition of Example 3 grew much less than the Pd particles of the comparative catalyst composition of Example 1 when exposed to aging conditions. Specifically, as determined from the comparative images provided in FIG. 3, the average Pd particle size in the comparative catalyst composition of Example 1 grew from about 1-2 nm to about 100 nm or more after aging, while the average Pd particle size in the catalyst composition of Example 3 grew from about 20-25 nm to about 50-60 nm. These comparative images are provided in FIG. 3, with the comparative catalytic material of Example 1 represented as FIG. 3A and the catalytic material of Example 3 represented as FIG. 3B. These results clearly demonstrate the advantage of using Pd nanoparticles dispersed on a refractory metal oxide support material as compared with Pd impregnated on a refractory metal oxide support, e.g., from Pd nitrate solution. Pd sintering (and thus, growth in particle size) upon aging is significantly less prominent for compositions comprising Pd nanoparticles as compared to compositions comprising Pd impregnated using Pd nitrate solution, in spite of the fact that the Pd particles of the compositions comprising Pd nanoparticles are larger initially (in fresh/calcined form) than the composition comprising Pd impregnated using Pd nitrate solution.

### Example 6

### Catalytic Activity Comparison

Various Testing Protocols were used to compare Comparative Example 2 and Example 3, as outlined below.

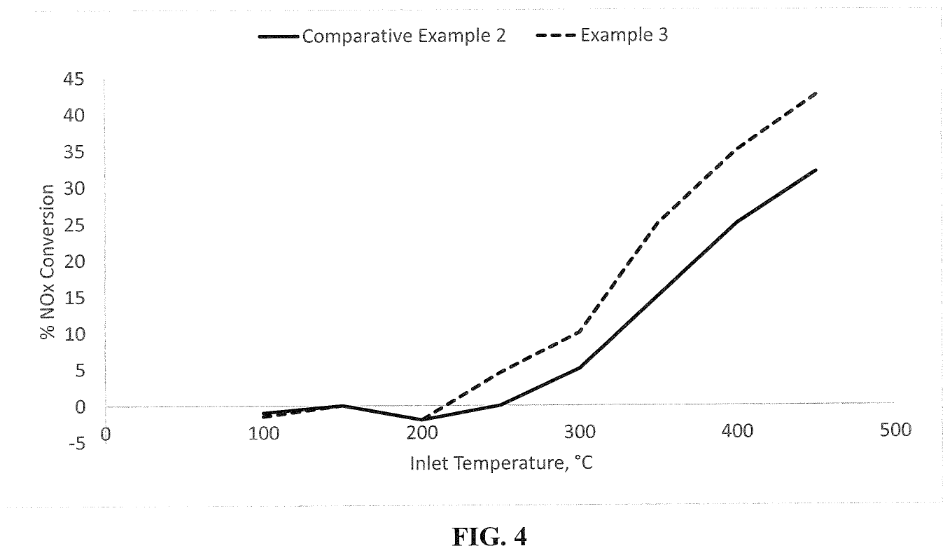

Protocol A: The two powder materials were evaluated after 1050° C. aging in 10% steam/air for 5 hours. The gas composition used for measuring catalytic activity was: O₂=1.2 vol %, CO=0.75 vol %, NO=1500 ppm, C₃H₆=3000 ppm, H₂O=5 vol %, balance He (Lean Lambda about 1.02). The results of propylene conversion, as provided in Table 1 below, show that the catalyst composition of Example 3, comprising Pd nano particles supported on alumina is more active under this protocol after 1050° C. aging than the comparative catalyst composition of Example 2. Similarly, the results of NOₓ conversion, shown in FIG. 4, illustrate that the catalyst composition of Example 3 was more active than the comparative catalyst composition of Example 2.

TABLE 1
Propylene Conversions using Protocol A

| | Propylene conversion (%) | |
|---|---|---|
| Catalyst Temperature (° C.) | Comparative Example 2 | Example 3 |
| 300 | 5 | 13 |
| 350 | 17 | 25 |
| 400 | 25 | 38 |
| 450 | 38 | 50 |

Protocol B: The two powder materials were evaluated after 1050° C. aging in 10% steam/air for 5 hours. The gas composition used for measuring catalytic activity was: CO=2.5 vol %, NO=1500 ppm, H₂O=5 vol %, O₂=0.5 vol %, balance He. The results of NOₓ conversion, as provided in Table 2 below, show that the catalyst composition of Example 3, comprising Pd nano particles supported on alumina is more active under this protocol after 1050° C. aging than the comparative catalyst composition of Example 2.

TABLE 2
NOₓ Conversions using Protocol B

| | NOₓ Conversion (%) | |
|---|---|---|
| Catalyst Temperature (° C.) | Comparative Example 2 | Example 3 |
| 250 | 13 | 18 |
| 300 | 42 | 54 |
| 350 | 58 | 65 |

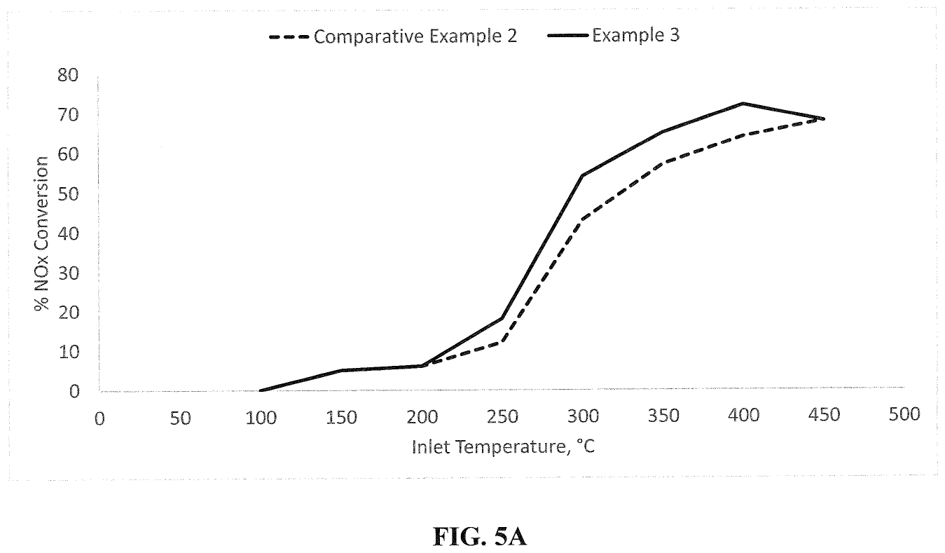

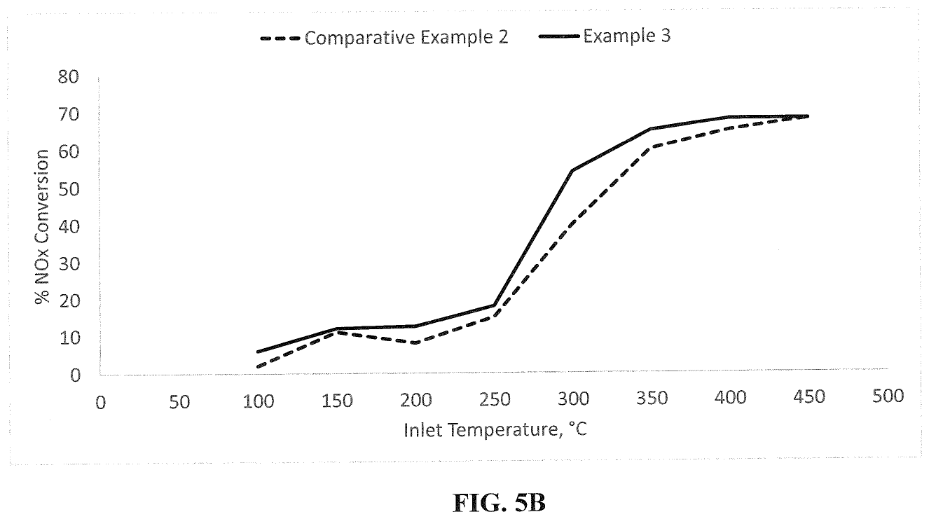

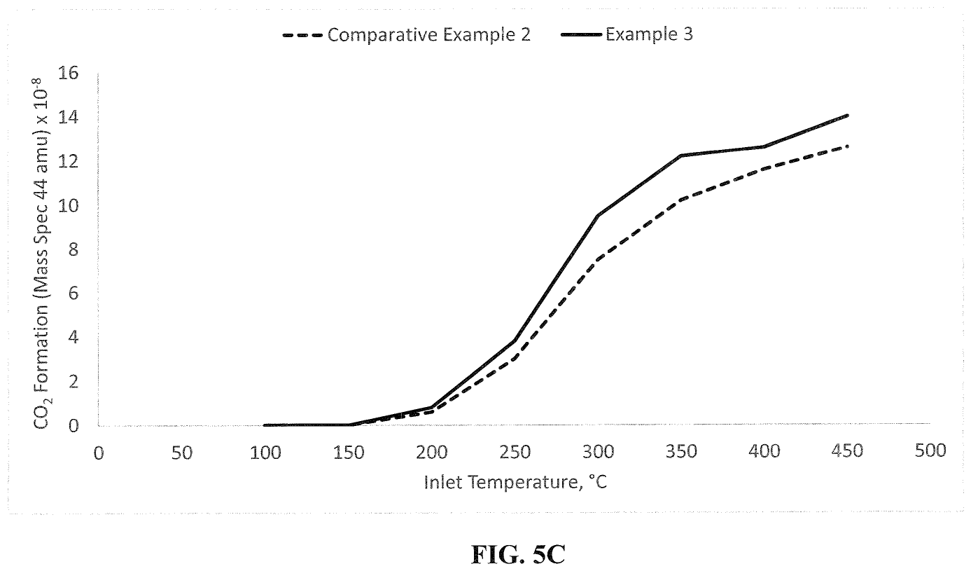

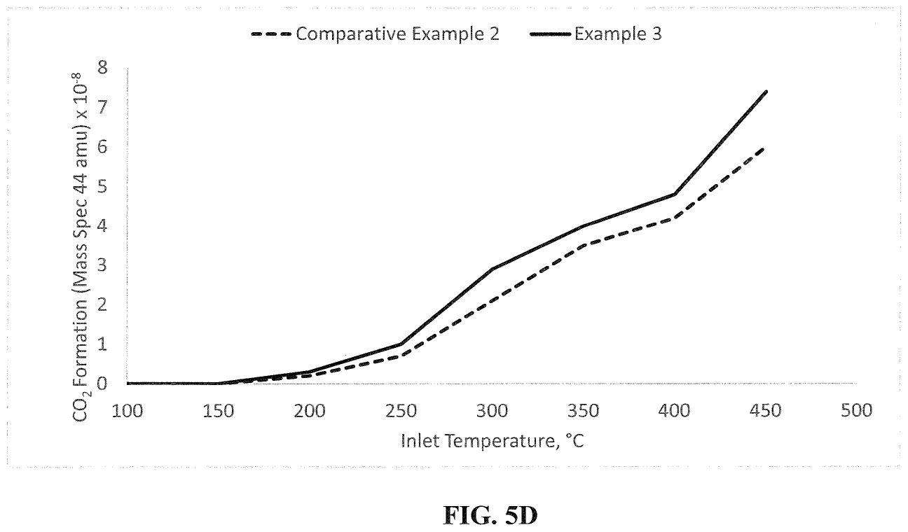

Protocol C: The two powder materials were evaluated after 1050° C. aging in 10% steam/air for 5 hours. The gas composition used for measuring catalytic activity was: CO=1.5 vol %, NO=1500 ppm, H₂O=5 vol %, balance He (Lean Lambda about 0.97). A comparison of the results of NOₓ conversion and CO₂ formation for Protocols B and C are shown in FIGS. 5A-5D, and illustrate that that the catalyst composition of Example 3, comprising Pd nano particles supported on alumina is more active under these protocols after 1050° C. aging than the comparative catalyst composition of Example 2.

While the invention herein disclosed has been described by means of specific embodiments and applications thereof, numerous modifications and variations could be made thereto by those skilled in the art without departing from the scope of the invention set forth in the claims. Furthermore, various aspects of the invention may be used in other applications than those for which they were specifically described herein.

1. A three-way conversion catalyst composition comprising:
a plurality of platinum group metal (PGM) nanoparticles selected from the group consisting of nanoparticles of Pt, Pd, Au, Rh, alloys thereof, and mixtures thereof,
wherein the nanoparticles have an average particle size of 15 to 50 nm,
wherein the nanoparticles are dispersed on a refractory metal oxide component, and
wherein the catalyst composition is in calcined form and is effective for carrying out three-way conversion.

2. A three-way conversion catalyst composition of claim 1, the composition comprising:
a plurality of platinum group metal (PGM) nanoparticles selected from the group consisting of nanoparticles of Pt, Pd, Au, Rh, alloys thereof, and mixtures thereof,
wherein the nanoparticles have an average particle size of about 15 to about 50 nm and at least 90% of the nanoparticles have a particle size within about 15 to about 50 nm,
wherein the nanoparticles are dispersed on a refractory metal oxide component, and
wherein the catalyst composition is in calcined form and is effective for carrying out three-way conversion.

3. The three-way conversion catalyst composition of claim 1, wherein the plurality of PGM nanoparticles comprises a plurality of Pt nanoparticles, Pd nanoparticles, Rh nanoparticles, or a combination thereof.

4. The three-way conversion catalyst composition of claim 1, wherein the refractory metal oxide component is selected from the group consisting of activated alumina, lanthana-alumina, lanthana-zirconia, baria-alumina, ceria-alumina, ceria-lanthana-alumina, zirconia-alumina, ceria-zirconia cerin-zirconia-alumina, and combinations thereof.

5. The three-way conversion catalyst composition of claim 1, wherein the PGM nanoparticles comprise palladium nanoparticles and the refractory metal oxide component comprises alumina, or ceria-zirconia.

6. (canceled)

7. (canceled)

8. (canceled)

9. (canceled)

10. A catalyst article comprising a catalyst substrate having a plurality of channels adapted for gas flow, each channel having a coating thereon, the coating comprising the three-way conversion catalyst composition of claim 1.

11. The catalyst article of claim 10, wherein the catalyst substrate is a metal or ceramic honeycomb substrate.

12. The catalyst article of claim 10, wherein the catalyst substrate is a wall flow filter or a flow through substrate.

13. The catalyst article of claim 10, wherein the three-way conversion catalyst composition is present on the catalyst substrate in a loading of at least about 0.5 g/in³.

14. The catalyst article of claim 10, wherein the coating comprises a single layer comprising the three-way conversion catalyst composition.

15. The catalyst article of claim 10, wherein the coating comprises two or more layers and wherein a top or bottom layer of the coating comprises the three-way conversion catalyst composition.

16. The catalyst article of claim 10, wherein the three-way conversion catalyst composition is zoned on one or both ends of the catalyst substrate such that the three-way conversion catalyst composition extends less than the full length of the catalyst substrate.

17. The catalyst article of claim 10, further comprising a second catalyst composition comprising one or more platinum group metals impregnated on a second refractory metal oxide component by traditional impregnation methods,

18. The catalyst article of claim 17, wherein the three-way conversion catalyst o position and the second catalyst composition are in admixture.

19. The catalyst article of claim 17, wherein the three-way conversion catalyst and the second catalyst composition are layered.

20. An exhaust gas treatment system comprising the catalyst article of claim 10 downstream of an automotive engine.

21. A method of making the three-way conversion catalyst composition of claim 1, comprising:
a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds;
b) combining the solution with a reducing agent to provide PGM nanoparticles;
c) dispersing the PGM nanoparticles on a refractory metal oxide support to provide supported PGM nanoparticles; and
d) calcining the supported PGM nanoparticles.

22. A method of making the three-way conversion catalyst composition of claim 1, comprising:
a) preparing a solution of platinum group metal (PGM) precursors selected from salts of Pt, Pd, Au, Rh, and alloys thereof in the presence of a dispersion medium and a water soluble polymer suspension stabilizing agent, wherein the PGM precursors are substantially free of halides, alkali metals, alkaline earth metals and sulfur compounds;
b) combining the solution with a refractory metal oxide support and a reducing agent to provide supported PGM nanoparticles comprising the PGM nanoparticles dispersed on the refractory metal oxide support; and
c) calcining the supported PGM nanoparticles.

23. The method of claim 21, wherein the PGM precursors are salts of Pt, Pd, or alloys thereof
wherein the platinum croup metal precursors are selected from the croup consisting of alkanolamine salts, hydroxy salts, nitrates, carboxylic acid salts, ammonium salts, and oxides, wherein the solid support material is selected from the group consisting activated alumina, lanthana-alumina, lanthana-zirconia, baria-alumina, cerin-alumina, cerin-lanthana-alumina, zirconia-alumina, ceria-zirconia ceria-zirconia-alumina, and combinations thereof.

24. (canceled)

25. (canceled)

26. A method for treating an exhaust gas comprising hydrocarbons, carbon monoxide, and nitrogen oxides comprising: contacting the exhaust gas with the three-way conversion catalyst composition of claim 1.

27. The method of claim 22, wherein the PGM precursors are salts of Pt, Pd, or alloys thereof wherein the platinum group metal precursors are selected from the group consisting of alkanolamine salts, hydroxy salts, nitrates, carboxylic acid salts, ammonium salts, and oxides, wherein the solid support material is selected from the group consisting activated alumina, lanthana-alumina, lanthana-zirconia, baria-alumina, cerin-alumina, ceria-lanthana-alumina, zirconia-alumina, ceria-zirconia ceria-zirconia-alumina, and combinations thereof.

28. A method for treating an exhaust gas comprising hydrocarbons, carbon monoxide, and nitrogen oxides comprising: contacting the exhaust gas with the catalyst article of claim 10.
